(19) United States
(12) Patent Application Publication
(10) Pub. No.: US 2010/0282039 A1
(43) Pub. Date: Nov. 11, 2010

(54) SPREADER ASSEMBLY FOR TABLE SAW

(75) Inventor: Long-Chang JAN, Changhua County (TW)

Correspondence Address: BROWDY AND NEIMARK, P.L.L.C.;624 NINTH STREET, NW, SUITE 300, WASHINGTON, DC, 20001-5303, US

(73) Assignee: OAV EQUIPMENT & TOOLS, INC., Shen Kang Hsiang (TW)

(21) Appl. No.: 12/490,707

(22) Filed: Jun. 24, 2009

(30) Foreign Application Priority Data
May 5, 2009 (TW) 98203364

(51) Int. Cl. B27B 5/06; B26D 7/22; B27G 19/02

(52) U.S. Cl. 83/102.1; 83/440.2

(57) ABSTRACT

A spreader assembly includes a spreader having a notch and two opposite indentations at a periphery of the notch, a holder, on which an anti-kickback pawl device is mounted, having a groove for insertion of the spreader, and a controller rotatably mounted to the holder and rotatable relative to the holder between a first position where two block portions of the controller are engaged with the indentations of the spreader for mounting the holder to the spreader, and a second position where the block portions of the controller are disengaged from the indentations of the spreader for allowing detachment of the holder from the spreader.

### BACKGROUND OF THE INVENTION

1. Field of the Invention

The present invention relates generally to an accessory of a table saw, and more specifically to a spreader assembly for a table saw, which includes a spreader and an anti-kickback pawl device that can be quickly mounted to and dismounted from the spreader through quick-release means.

2. Description of the Related Art

When a workpiece is placed on a worktable of a table saw and pushed toward a saw blade for cutting by the saw blade, the cut part of the workpiece may impart a clamping force to the saw blade because of the applied push force and the rebound force of the cut part of the workpiece, enhancing a friction between the workpiece and the saw blade and hindering feeding of the workpiece. To avoid this problem, the table saw is usually equipped with a spreader that can be inserted into the kerf cut by the saw blade to maintain separation of the cut part of the workpiece, thereby facilitating cutting operation and workpiece feeding and assuring cutting safety.

Further, the saw blade of the table saw is designed in cooperation with a lifting mechanism such that the saw blade is adjustable in its elevation so as to cut workpieces with different thicknesses. In light of this, the spreader of the table saw is usually designed to be detachably mounted to the lifting mechanism of the saw blade. Taiwan Patent Publication No. 200904609 discloses a quick-release structure for a guard assembly of a table saw, enabling a guard assembly to be quickly mounted to and dismounted from a spreader that is mounted to the lifting mechanism of the saw table and vertically moveable along with the saw blade.

The present invention provides another approach for quickly assembling and disassembling a spreader assembly including a spreader and an anti-kickback pawl device through quick-release means.

### SUMMARY OF THE INVENTION

It is one objective of the present invention to provide a spreader assembly for a table saw, which can be quickly assembled and disassembled through quick-release means.

To achieve this objective of the present invention, the spreader assembly comprises a spreader, an anti-kickback pawl device and a quick-release device, on which the anti-kickback pawl device is mounted, for detachably mounting the anti-kickback pawl device with the spreader. The spreader has a notch and two opposite indentations located at a periphery of the notch. The quick-release device comprises a holder having a groove for insertion of the spreader, and a controller provided with two block portions and rotatably mounted to the holder. The controller is rotatable relative to the holder between a first position and a second position. When the controller is located at the first position, the block portions of the controller are engaged with the indentations of the spreader for mounting the holder to the spreader, and when the controller is located at the second position, the block portions of the controller are disengaged from the indentations of the spreader for allowing dismounting of the holder from the spreader.

By means of turning the controller to the second position, the holder of the quick-release device on which the anti-kickback pawl device is mounted can be detached from the spreader quickly.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a spreader assembly according to a preferred embodiment of the prevent invention, showing the holder is disengaged from the spreader;

FIG. 2 is a partial exploded view of the spreader assembly according to a preferred embodiment of the prevent invention;

FIG. 3 is a partial cutaway view of the spreader assembly according to a preferred embodiment of the prevent invention, showing the controller is in the first position, and

FIG. 4 is similar to FIG. 3, but showing the controller is in the second position.

### DETAILED DESCRIPTION OF THE INVENTION

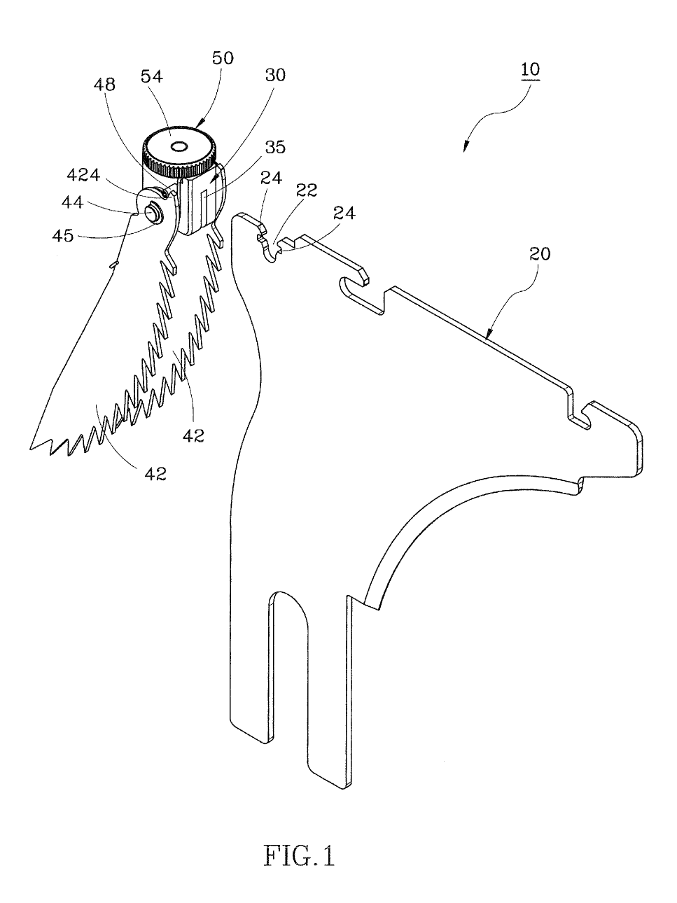

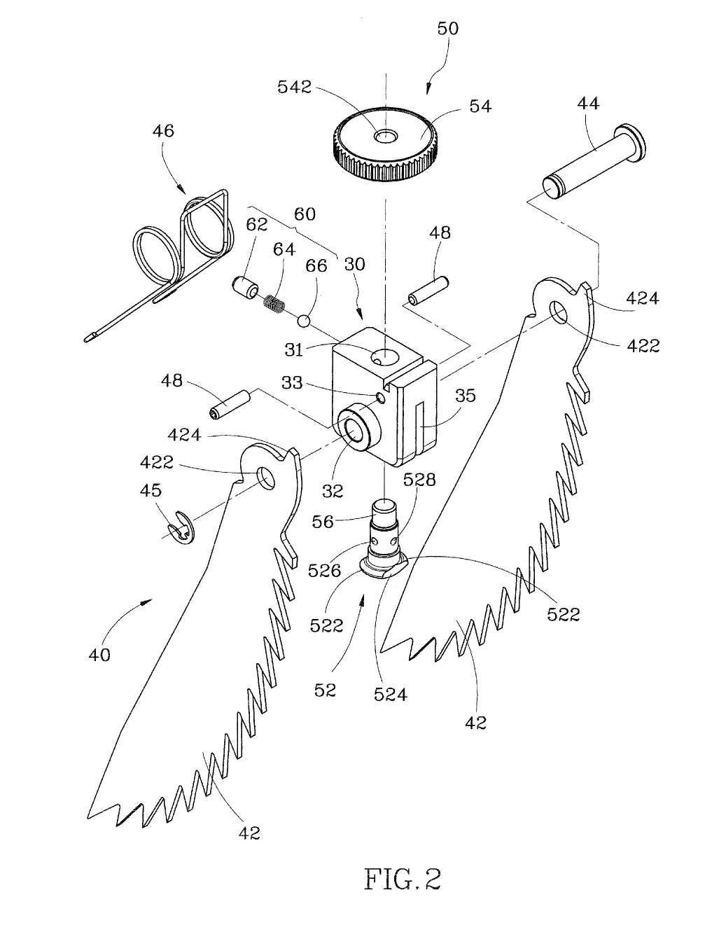

As shown in FIGS. 1 and 2, a spreader assembly 10 in accordance with a preferred embodiment of the present invention comprises a spreader 20, a quick-release device including a holder 30, a controller 50 and a positioning unit 60, and an anti-kickback pawl device 40.

The spreader 20 is connected to a lifting mechanism of a saw blade (not shown) such that the spreader 20 is vertically movable along with the saw blade. The spreader 20 is located behind the saw blade for maintaining separation of the cut part of a workpiece. The spreader 20 has a notch 22 at a top side thereof, and two opposite indentations 24 located at a periphery of the notch 22.

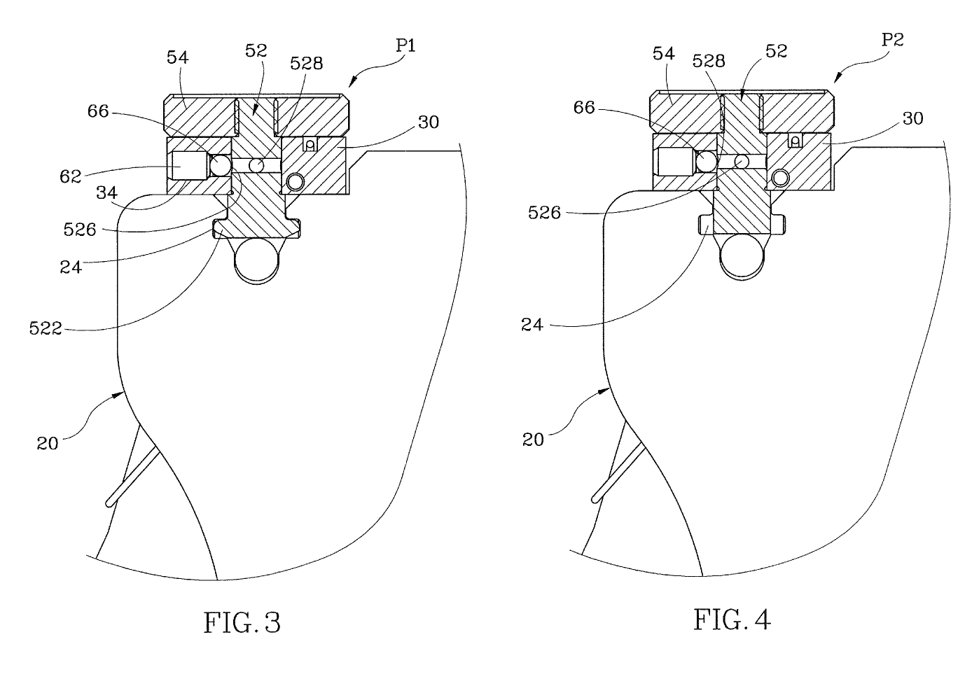

The holder 30 has a first through hole 31 through top and bottom sides thereof, a second through hole 32 through left and right sides thereof a third through hole 33 above the second hole 32, a forth through hole 34 recessed from the rear side thereof toward the first through hole 31 and communicated with the first through hole 31, as shown in FIG. 3, and a groove 35 for insertion of the spreader 20.

The anti-kickback pawl device 40 has two pawls 42, a pivot 44, a torsion spring 46, and two pins 48. The pawls 42 are located at the left and right sides of the holder 30, and respectively provided with a pivoting hole 422 aligned with the second through hole 32, and a protrusion 424. The pivot 44 passes through the pivoting holes 422 of the pawls 42 and the second through hole 32 of the holder 30, and is retained to the pawls 42 and the holder 30 through a fastener 45 fastened to a distal end of the pivot 44, such that the pawls 42 are pivotable relative to the holder 30 for preventing the backward movement of the workpiece during cutting operation. The torsion spring 46 is disposed on the pivot 44, having two distal ends respectively engaged with the pawls 42 for forcing the pawls 42 to be pivotally moved to an initial position. The pins 48 are inserted into the third through hole 33 of the holder 30 to stop the protrusions 424 of the pawls 42 for preventing excessive pivotal movement of the pawls 42 caused by the torsion spring 46.

The controller 50 has a shaft 52 and a rotary button 54. The shaft 52 passes through the first through hole 31 of the holder 30, having two opposite curved surfaces 522 defining block portions at a head thereof, two opposite planes 524 staggered with the curved surfaces 522, a threaded portion 56 at a tail thereof and first and second positioning holes 526 and 528 spaced 90 degrees at an outer periphery thereof. The rotary button 54 has a threaded hole 542 at a middle thereof to be threaded with the threaded portion 56 of the shaft 52 such that the shaft 52 is rotatable between a first position P1 and a second position P2 by the rotation of the rotary button 54. When the shaft 52 is located at the first position P1, the curved surfaces 522 (i.e. the block portions) of the shaft 52 are engaged with the indentations 24 of the spreader 20, as shown in FIG. 3, and when the shaft 52 is located at the second position P2, the curved surfaces 522 (i.e. the block portions) of the shaft 52 are disengaged from the indentations 24 of the spreader 20, as shown in FIG. 4.

The positioning unit 60 is mounted in the forth hole 34 of the holder 30, including a post 62, a spring member 64 received in the post 62, and a ball 66 stopped against the spring member 64 and pushed into contact with one of the first and second positioning holes 526 and 528 alternatively for maintaining the shaft 52 in the first or second position P1 or P2, as shown in FIGS. 3 and 4.

In order to assemble the holder 30 with the spreader 20, a user can insert the spreader 20 into the groove 35 of the holder 30 in such a way that the head of the shaft 52 is accommodated in the notch 22 of the spreader 20, and then turn the rotary button 54 to drive the shaft 52 to rotate to the second position P2 for allowing the curved surfaces 522 (i.e. the block portions) of the shaft 52 to be engaged with the indentations 24 of the spreader 20, as shown in FIG. 3, thereby completing the assembly of the spreader assembly 10.

In order to disassemble the holder 30 from the spreader 20, the user can rotate the shaft 54 from the first position P1 to the second position P2 by turning the rotary button 54 for enabling the curved surfaces 522 (i.e. the block portions) of the shaft 52 to be disengaged from the indentations 24 of the spreader 20, as shown in FIG. 4. Thus, the head of the shaft 52 can be moved away from the notch 22 of the spreader 20, causing the detachment of the holder 30 from the spreader 20.

As indicated above, the anti-kickback pawl device 40 can be quickly mounted to and dismounted from the spreader 20 by means of the quick-release device. In other words, the spreader assembly of the present invention has a simple structure, and provides a quick and convenient way to complete its assembly and disassembly through the rotation of the controller of the quick-release device.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A spreader assembly comprising a spreader, an anti-kickback pawl device and a quick-release device, on which the anti-kickback pawl device is mounted, for detachably mounting the anti-kickback pawl device with the spreader;
wherein the spreader has a notch and two opposite indentations located at a periphery of the notch;
wherein the quick-release device comprises:
a holder having a groove for insertion of the spreader; and
a controller rotatably mounted to the holder and provided with two block portions, the controller being rotatable relative to the holder between a first position where the block portions of the controller are engaged with the indentations of the spreader for retaining the holder to the spreader, and a second position where the block portions of the controller are disengaged from the indentations of the spreader for allowing detachment of the holder from the spreader.

2. The spreader assembly as claimed in claim 1, wherein the controller includes a shaft passing through the holder and having the block portions, and a rotary button connected to a distal end of the shaft and located at a top surface of the holder for driving the shaft to rotate.

3. The spreader assembly as claimed in claim 2, wherein the shaft of the controller has two opposite curved surfaces defining the block portions, and two opposite planes.

4. The spreader assembly as claimed in claim 2, further comprising a positioning unit fitted into a first positioning hole of the shaft of the controller when the controller is in the first position, and fitted into a second positioning hole of the shaft of the controller when the controller is in the second position.

5. The spreader assembly as claimed in claim 4, wherein the positioning unit includes a spring member, and a ball stopped against the spring member and fitted into one of the first positioning hole and the second positioning hole alternatively.

6. The spreader assembly as claimed in claim 2, wherein the rotary button of the controller has a threaded hole, and the shaft of the controller has a threaded portion at the distal end thereof threaded with the threaded hole of the rotary button.

7. The spreader assembly as claimed in claim 1, wherein the anti-kickback pawl device comprises two pawls pivotally mounted to two opposite sides of the holder of the quick-release device.
